(19) United States
(12) Patent Application Publication
(10) Pub. No.: US 2008/0205064 A1
(43) Pub. Date: Aug. 28, 2008

(54) Lamp Assembly Comprising a Uv-Enhancer

(75) Inventor: Leo Ooms, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/813,123

(22) PCT Filed: Jan. 4, 2006
(86) PCT No.: PCT/IB06/50024

§ 371 Date: Jun. 29, 2007

(30) Foreign Application Priority Data
Jan. 12, 2005 (EP) 05100135.2

(51) Int. Cl. F21V 7/00

(52) U.S. Cl. 362/310

(57) ABSTRACT

A lamp assembly, comprising a high-pressure discharge lamp (4) and a reflector (1) surrounding at least a part of said lamp (4). The lamp (4) comprises a bulb made of glass, which bulb encloses a gas discharge space (5) in which a first electrode (6) and a second electrode (7) are present. The bulb also encloses a second space (41) containing a part of an electric conductor (8) for supplying electric current to the first electrode (6), which second space (41) is filled with an ionizable gas. The reflector (1) comprises an electrically conductive portion (42) which substantially surrounds the part of the lamp (4) in which said second space (41) is present, said conductive portion (42) being electrically connected to the second electrode (7).

The invention relates to a lamp assembly comprising a high-pressure discharge lamp and a reflector surrounding at least a part of said lamp, wherein the lamp comprises a bulb made of glass, in particular quartz glass, which bulb encloses a gas discharge space in which a first electrode and a second electrode are present, said bulb also enclosing a second space containing a part of an electric conductor for supplying electric current to the first electrode, which second space is filled with an ionizable gas.

A high-pressure discharge lamp having such a second space is disclosed in U.S. Pat. No. 6,563,267, which publication describes a lamp having a bulb with sealed portions at two opposite ends, wherein each sealed portion comprises an electric conductor for supplying electric current to one of the electrodes. Each electric conductor comprises a molybdenum (Mo) foil having knife edges, and said second space, enclosing an ionizable gas, surrounds a part of the molybdenum foil in at least one of the sealed portions. At the location of said second space, the bulb of the lamp is surrounded by an antenna, made of electrically conductive material, which antenna is electrically connected to the second electrode, i.e. the electrode that is not electrically connected to the molybdenum foil in said second space.

When the lamp is switched on, electric current is supplied to the two electrodes, causing a gas discharge in the gas discharge space of the bulb, and resulting in light radiation from the gas discharge space. It may take some time before the light radiation starts, in particular when the lamp has been in a dark environment for some time. Such an ignition delay of the lamp can be shortened by means of UV-radiation, as is described in U.S. Pat. No. 6,563,267. Said second space constitutes a source of UV-radiation when applying an electric voltage across this space, and such an electric voltage is caused by the difference of electric potential between the part of the conductor in said second space on the one side and the antenna around the bulb of the lamp at the location of said second space on the other side. The UV-radiation source is also called a UV-enhancer.

As described in U.S. Pat. No. 6,563,267, said second space in the bulb of the lamp may be made in a relatively easy manner during the normal process of manufacturing the high-pressure discharge lamp. However, the antenna around the bulb of the lamp is an additional part of the lamp, which part must be made in a separate operation. Consequently, the lamp comprising the UV-enhancer is a more complex and more expensive lamp than the lamp without such a UV-enhancer.

It is an object of the invention to provide a lamp assembly comprising a high-pressure discharge lamp and a reflector surrounding at least a part of said lamp, wherein the lamp is provided with a UV-enhancer including an antenna surrounding a part of the bulb of the lamp, which makes the lamp assembly less complex and thus less expensive to manufacture than an existing lamp assembly comprising such a UV-enhancer.

To achieve this object, the reflector comprises an electrically conductive portion which substantially surrounds the part of the lamp in which said second space is present, said conductive portion of the reflector being electrically connected to the second electrode, i.e. the electrode that is not electrically connected to the molybdenum foil in said second space. The electrically conductive portion of the reflector can then function as the antenna for establishing a voltage across said second space. It is relatively easy to apply the conductive portion of the reflector to the reflector during the process of manufacturing the reflector and it does not form an additional part of the lamp assembly.

In one preferred embodiment, the bulb of the lamp comprises two sealed portions, preferably at opposite ends of the bulb, wherein said second space is located in at least one of the two sealed portions. As mentioned above, and as described in U.S. Pat. No. 6,563,267, it is relatively easy to create said second space in a sealed portion of the bulb of the lamp. The bulb is preferably connected to the reflector through the sealed portion that comprises said second space, so that the second space is located near the reflector.

The electrically conductive portion of the reflector may be an additional layer of conductive material in or on the reflector. However, in a preferred embodiment, at least a part of the surface of the reflector is provided with a light-reflecting coating, wherein at least a part of said light-reflecting coating is electrically conductive. The reflector may be a glass body (glass-ceramic or quartz) provided with a light-reflecting coating on a part of its surface. Such a coating often comprises one layer or a number of layers of material, and one or more of these layers is electrically conductive, or can be made electrically conductive. Also, an additional electrically conductive layer can be added to the light-reflecting coating. The electrically conductive layer can be electrically connected to said second electrode, so that the part of this layer near said second space of the lamp functions as the antenna and, together with the part of the electric conductor for supplying electric current to said first electrode, can create a voltage across said second space in order to function as UV-enhancer.

In one preferred embodiment, said electrically conductive portion of the reflector is present on the surface of a substantially cylindrical bore in the material of the reflector, the part of the lamp in which said second space is present being located in said bore. The antenna of the UV-enhancer can then be positioned close to the bulb across the length of said second space, which improves the functioning of the antenna. The electrically conductive and light-reflecting coating is preferably present on the surface of said bore, so that the conductive coating in said bore and the light-reflective coating on the inner surface of the reflector can be applied in the same manufacturing operation.

The invention also relates to a reflector for a lamp assembly comprising a high-pressure discharge lamp and the reflector, which surrounds at least a part of said lamp, wherein the lamp comprises a bulb made of glass, which bulb encloses a gas discharge space in which a first electrode and a second electrode are present, said bulb also enclosing a second space containing a part of an electric conductor for supplying electric current to the first electrode, which second space is filled with an ionizable gas, the reflector being provided with an electrically conductive portion which substantially surrounds the part of the lamp in which said second space is present, said conductive portion being electrically connected to the second electrode.

These and other aspects of the invention are apparent from and will be elucidated with reference to the embodiments described hereinafter.

In the drawings,

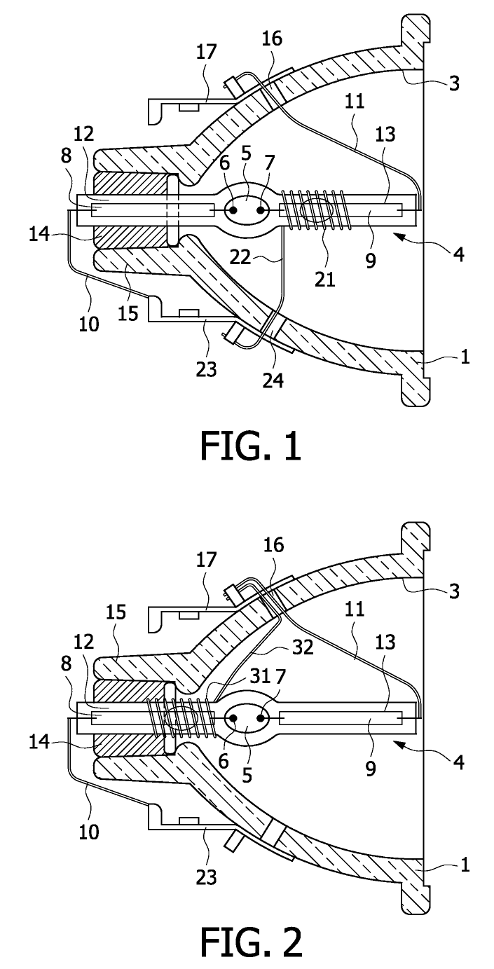

FIG. 1 shows a first prior-art lamp assembly;

FIG. 2 shows a second prior-art lamp assembly; and

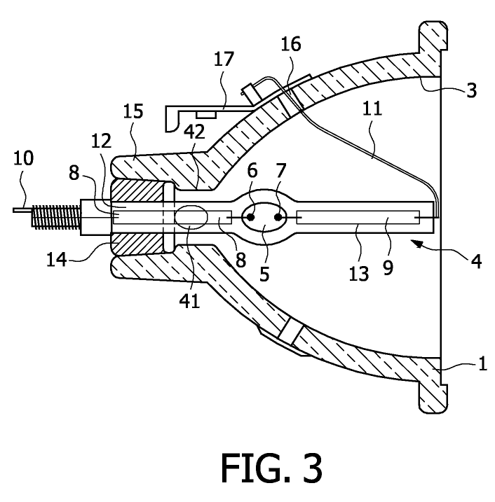

FIG. 3 shows an embodiment of the invention.

All of the three embodiments, i.e. the two prior-art lamp assemblies (FIGS. 1 and 2) as well as the embodiment according to the invention (FIG. 3), have a reflector 1 mainly made of glass (glass, glass-ceramic or quartz), which reflector 1 is bell-shaped and is shown in a sectional view, wherein its central axis is in the plane of the drawing. The reflector 1 is provided with a light-reflecting coating 3 on its parabolic (or elliptical) inner surface. A high-pressure gas discharge lamp 4 is mounted in the reflector 1, so that the gas discharge space 5 of the bulb of the lamp 4 is located near the focus of said parabolic (or elliptical) shape. The gas discharge space 5 accommodates two electrodes 6,7, each being electrically connected to current supply wires 10,11 through a molybdenum foil 8,9. Each molybdenum foil 8,9 is located in a sealed portion 12,13 of the bulb of the lamp 4, wherein the two sealed portions 12,13 extend outwardly in opposite directions.

The lamp 4 is attached to the reflector 1 through one of the sealed portions, which sealed portion 12 is embedded in cement 14 which is present in the neck 15 of the reflector 1. The cement 14 provides a non-detachable and solid connection between the reflector 1 and the lamp 4, wherein the gas discharge space 5 is kept exactly at the desired location, in order to obtain a predetermined shape of the light beam produced by the lamp assembly. The other sealed portion 13 extends along the centerline of the parabolic (or elliptical) shape of the reflector 1. The wire 11 for supplying electric current to electrode 7 leaves the bulb of the lamp 1 at the end of the sealed portion 13, passes the wall of the reflector 1 through a bore 16, and is connected to a first electric contact element 17 which is attached to the reflector 1, so that it can be connected to an electric current supply wire of the electric power supply for the lamp 1. The wire 10 for supplying electric current to electrode 6 is embedded in sealed portion 12 and leaves the bulb of the lamp 1 at the rear side of the lamp assembly.

FIG. 1 shows a lamp assembly wherein the UV-enhancer consists of a second space around a part of the molybdenum foil 9 in sealed portion 13 and an antenna 21 surrounding a part of sealed portion 13 at the location of the second space. The antenna 21 is connected to a second electric contact element 23 by means of wire 22 which passes the wall of the reflector 1 through a bore 24 in the wall of the reflector 1. Also wire 10 is connected to the second electric contact element 23, so that electric power can be supplied to the lamp through the first and the second electric contact elements 17,23.

In order to switch on the lamp 1, electric power is supplied to the electric contact elements 17,23, and is guided to the electrodes 6,7 through the wires 10,11 and the molybdenum foils 8,9. Furthermore, electric power is supplied to antenna 21 through electric contact element 23 and wire 22. This establishes an electric field between the antenna 21 and the molybdenum foil 9, producing UV-radiation from the second space, which UV-radiation enhances the start of the gas discharge in gas discharge space 5.

FIG. 2 shows a lamp assembly wherein the UV-enhancer consists of a second space around a part of the molybdenum foil 8 in sealed portion 12 and an antenna 31 surrounding a part of sealed portion 12 at the location of the second space. The antenna 31 is connected to the first electric contact element 17 by means of wire 32, and passes the wall reflector 1 through bore 16, together with electric current supply wire 11. The electric current supply wire 10 is connected to second electric contact element 23, so that electric power can be supplied to the lamp through the first and the second electric contact elements 17,23.

When the lamp 1 is switched on, electric power is supplied to the electric contact elements 17,23, and is guided to the electrodes 6,7 through the wires 10,11 and the molybdenum foils 8,9. Furthermore, electric power is supplied to the antenna 31 through the electric contact element 17 and the wire 32. This establishes an electric field between the antenna 31 and the molybdenum foil 8, producing UV-radiation from the second space, which UV-radiation enhances the start of the gas discharge in gas discharge space 5.

FIG. 3 shows a lamp assembly according to the invention, wherein the UV-enhancer comprises a second space 41 around a part of the molybdenum foil 8 in the sealed portion 12 of the bulb of the lamp 4. The neck 15 of the reflector 1 is provided with a cylindrical bore 42, and the inner surface of this bore is covered with the same coating as the coating 3 on the parabolic (or elliptical) inner surface of the reflector 1. The coating 3 is light-reflecting as well as electrically conductive, so that it can be applied in one manufacturing operation on said parabolic (or elliptical) inner surface as well as on the inner surface of said cylindrical bore 42. In general, a reflecting coating of such a lamp is not electrically conductive, but, according to the invention, one or more layers of the coating comprise an electrically conductive material.

When the lamp is switched on, electric power is supplied to contact element 17 and to supply wire 10. The electric current is guided to electrode 7 from contact element 17 through wire 11 and molybdenum foil 9, and to electrode 6 from wire 10 through molybdenum foil 8, in order to generate a gas discharge in space 5 of the bulb of lamp 4. In order to improve the start of the gas discharge in space 5, UV-radiation is generated in space 41 by creating an electric field across space 41. The electric field is generated between the molybdenum foil 8 which is electrically connected to wire 10, and the inner surface of cylindrical bore 42, which is coated with electrically conductive material, is electrically connected to contact element 17.

The embodiments of the lamp assembly as described above are only examples; a great many other embodiments and variations are possible. For example, the front side of the reflector can be covered by a transparent plate made of glass.

1. A lamp assembly comprising a high-pressure discharge lamp and a reflector surrounding at least a part of said lamp, wherein the lamp comprises a bulb made of glass, which bulb encloses a gas discharge space in which a first electrode and a second electrode are present, said bulb also enclosing a second space containing a part of an electric conductor for supplying electric current to the first electrode, which second space is filled with an ionizable gas, characterized in that the reflector comprises an electrically conductive portion which substantially surrounds the part of the lamp in which said second space is present, said conductive portion of the reflector being electrically connected to the second electrode.

2. A lamp assembly as claimed in claim 1, characterized in that the bulb of the lamp comprises two sealed portions, preferably at opposite ends of the bulb, wherein said second space is located in at least one of the two sealed portions.

3. A lamp assembly as claimed in claim 2, characterized in that the bulb is connected to the reflector through the sealed portion comprising said second space.

4. A lamp assembly as claimed in 1, wherein at least a part of the surface of the reflector is provided with a light-reflecting coating, characterized in that at least a part of said light-reflecting coating is electrically conductive.

5. A lamp assembly as claimed in 1, characterized in that said electrically conductive portion of the reflector is present on the surface of a substantially cylindrical bore in the material of the reflector, the part of the lamp in which said second space is present being located in said bore.

6. A lamp assembly as claimed in claim 5, characterized in that an electrically conductive and light-reflecting coating is present on the surface of said bore.

7. A reflector for a lamp assembly comprising a high-pressure discharge lamp and the reflector, which surrounds at least a part of said lamp, wherein the lamp comprises a bulb made of glass, which bulb encloses a gas discharge space in which a first electrode and a second electrode are present, said bulb also enclosing a second space containing a part of an electric conductor for supplying electric current to the first electrode, which second space is filled with an ionizable gas, characterized in that the reflector is provided with an electrically conductive portion which substantially surrounds the part of the lamp in which said second space is present, said conductive portion being electrically connected to the second electrode.
